(19) United States
(12) Patent Application Publication
(10) Pub. No.: US 2017/0277954 A1
(43) Pub. Date: Sep. 28, 2017

(54) SYSTEM AND METHOD FOR EARLY DETECTING DISASTERS BASED ON SVM

(71) Applicants: AIRPOINT CO., LTD., Daejeon (KR); DAOOLDNS CO., LTD., Daegu (KR)

(72) Inventors: Yong Suk CHANG, Daegu (KR); Min Suk JUNG, Daegu (KR); Min Jun KIM, Daegu (KR); Sung Jun BAIK, Daejeon (KR); Ja Hyuk YOON, Gyeonggi-do (KR)

(21) Appl. No.: 15/085,731

(22) Filed: Mar. 30, 2016

(30) Foreign Application Priority Data
Mar. 28, 2016 (KR) 10-2016-0036767

(51) Int. Cl. G06K 9/00; G06T 7/00; G06K 9/66

(52) U.S. Cl. CPC G06K 9/00711; G06K 9/66; G06T 7/0081; G06K 2009/00738; G06T 2207/20144; G06T 2207/20081; G06T 2207/10016

(57) ABSTRACT

A system for early detecting disasters based on an SVM (Support Vector Machine) may include: an input unit configured to decode a plurality of input images and convert the decoded images into shared data; a shared data management unit configured to manage the shared data provided from the input unit; a processing unit configured to analyze the shared data provided from the shared data management unit based on an SVM learning algorithm, and detect whether a disaster situation occurred; and an output unit configured to output the detection result of the processing unit.

### CROSS-REFERENCE TO RELATED APPLICATIONS

The present application claims priority of Korean Patent Application No. 10-2016-0036767, filed on Mar. 28, 2016, which is incorporated herein by reference in its entirety.

### BACKGROUND

1. Field

Exemplary embodiments of the present invention relate to a system and method for early detecting disasters based on an SVM (Support Vector Machine), and more particularly, to a system and method for early detecting disasters based on an SVM, which receives images from a plurality of CCTV (Closed Circuit Television) cameras, detects a disaster or unusual situation (that is, a disaster situation), such as fire, flood, building abnormality (for example, abnormal exterior of building), distribution monitoring and unattended guarding, and informs a user of the unusual situation, and a computer readable recording medium which stores a program for embodying the method.

2. Description of the Related Art

Conventionally, they receive images from a plurality of CCTV cameras in order to monitor a security area. In most cases, however, they determine a disaster situation with manpower or cannot help but to analyze one or a few CCTV images due to a physical limit or cost limit, in order to determine whether a disaster situation occurred.

Thus there is a demand for a technology which can process images provided from a plurality of CCTV cameras at the same time, automatically analyze the CCTV images based on an SVM (Support Vector Machine) learning algorithm, and determine whether a disaster situation occurred.

### SUMMARY

Various embodiments are directed to a system and method for early detecting disasters based on an SVM, which analyzes images received from a plurality of CCTV cameras using an SVM learning algorithm, detects a disaster situation such as fire, flood, building abnormality, distribution monitoring, and unattended guarding and informs a user of the disaster situation, and a computer readable recording medium which stores a program for embodying the method.

In an embodiment, a system for early detecting disasters based on an SVM may include: an input unit configured to decode a plurality of input images and convert the decoded images into shared data; a shared data management unit configured to manage the shared data provided from the input unit; a processing unit configured to analyze the shared data provided from the shared data management unit based on an SVM learning algorithm, and detect whether a disaster situation occurred; and an output unit configured to output the detection result of the processing unit.

In an embodiment, a method for early detecting disasters based on an SVM may include: receiving encoded images from a plurality of cameras; decoding the received encoded images, and converting the decoded images into shared data; analyzing the images provided as the shared data based on an SVM learning algorithm, and determining whether a disaster situation occurred; and outputting the detection result.

In an embodiment, there is provided a computer readable recording medium which stores a program for embodying: receiving encoded images from a plurality of cameras; decoding the received encoded images, and converting the decoded images into shared data; analyzing the images provided as the shared data based on an SVM learning algorithm, and determining whether a disaster situation occurred; and outputting the detection result.

### BRIEF DESCRIPTION OF THE DRAWINGS

FIG. 1 is a configuration diagram illustrating a system for early detecting disasters based on an SVM in accordance with an embodiment of the present invention.

FIG. 2 is a detailed configuration diagram of an input unit of FIG. 1.

FIG. 3 is a detailed configuration diagram of a processing unit of FIG. 1.

FIG. 4 is a detailed configuration diagram of an output unit of FIG. 1.

FIG. 5 is a detailed configuration diagram of a single event processor of FIG. 3.

FIGS. 6A to 6C are flowcharts illustrating a method for early detecting disasters based on an SVM in accordance with an embodiment of the present invention.

### DETAILED DESCRIPTION

Various embodiments will be described below in more detail with reference to the accompanying drawings. The present invention may, however, be embodied in different forms and should not be construed as limited to the embodiments set forth herein. While the present invention is, described, detailed descriptions related to publicly known functions or configurations will be ruled out in order not to unnecessarily obscure subject matters of the present invention.

Throughout the specification, when an element is referred to as being connected or coupled to another element, it should be understood that the former can be directly connected or coupled to the latter, or electrically connected or coupled to the latter via an intervening element therebetween. Furthermore, when it is described that one element “comprises”, “includes” or “has” some elements, it should be understood that it may comprise (or include or has) only those elements, or it may comprise (or include or have) other elements as well as those elements if there is no specific limitation. The terms of a singular form may include plural forms unless referred to the contrary.

Hereafter, the embodiments of the present invention will be described with reference to the accompanying drawings.

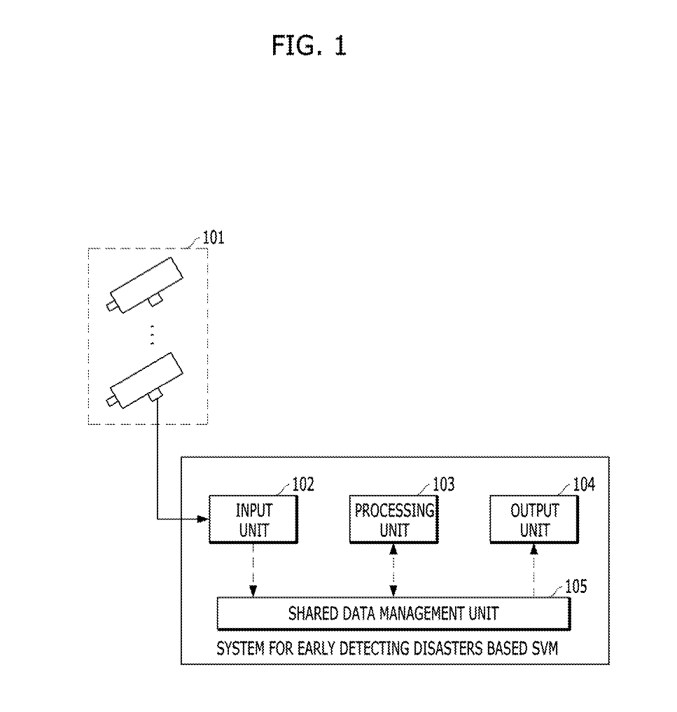

FIG. 1 is a configuration diagram illustrating a system for early detecting disasters based on an SVM (Support Vector Machine) in accordance with an embodiment of the present invention. The system may include a plurality of CCTV cameras 101, an input unit 102, a processing unit 103, an output unit 104, and a shared data management unit 105. The input unit 102, the processing unit 103 and the output unit 104 may correspond to main components of the system, and the shared data management unit 105 may manage shared data of the three main components.

As illustrated in FIG. 1, the system for early detecting disasters based on an SVM in accordance with the embodiment of the present invention may include the input unit 102, the shared data management unit 105, the processing unit 103 and the output unit 104. The input unit 102 may decode a plurality of CCTV images and convert the decoded CCTV images into shared data. The shared data management unit 105 may manage the shared data from the input unit 102. The processing unit 103 may analyze the shared data from the shared data management unit 105 based on an SVM learning algorithm, and detect whether a disaster situation occurred. The output unit 104 may output the CCTV images and the information on the disaster situation occurrence.

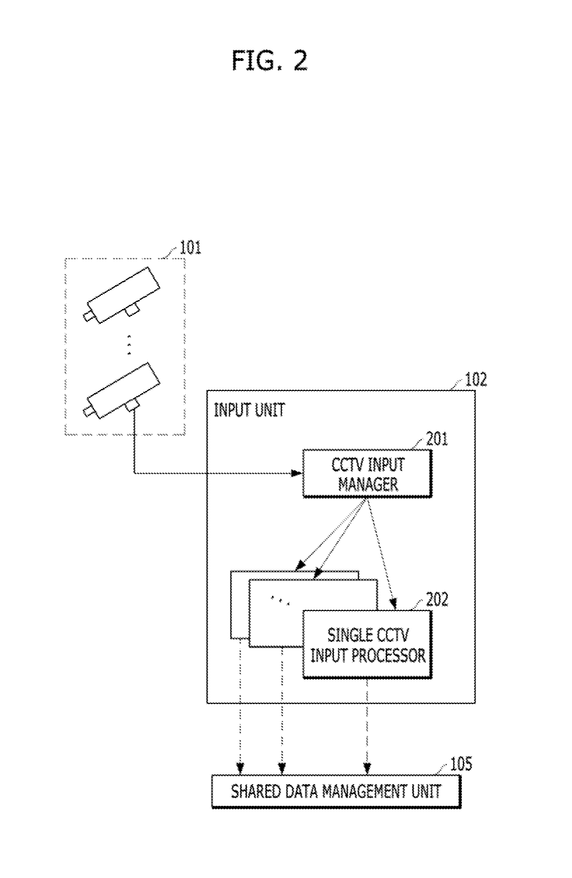

At this time, the input unit 102 may receive the encoded CCTV images from the plurality of CCTV cameras 101, decode the received CCTV images, and convert the decoded CCTV images into shared data. That is, the input unit 102 may receive the encoded CCTV images from the plurality of CCTV cameras 101 existing in a local or remote area, decode the received CCTV images into the shared data, and transmit the shared data to the shared data management unit 105. For this operation, the input unit 102 may determine the number of CCTV camera inputs, using the CCTV images inputted from the plurality of CCTV camera 101, and generate single CCTV input processor instances of FIG. 2. Such series of operations may be independently performed on the respective CCTV images by the plurality of single CCTV input processors 202, thereby processing different CCTV images at the same time.

The shared data management unit 105 may serve to manage the shared data provided through the input unit 102 such that the processing unit 103 and the output unit 104 can use the shared data. That is, the shared data management unit 105 may retain and manage the shared data received from the input unit 102, and transmit events such as the CCTV image inputs and the shared data to the processing unit 103 and the output unit 104, such that the respective units process the corresponding events.

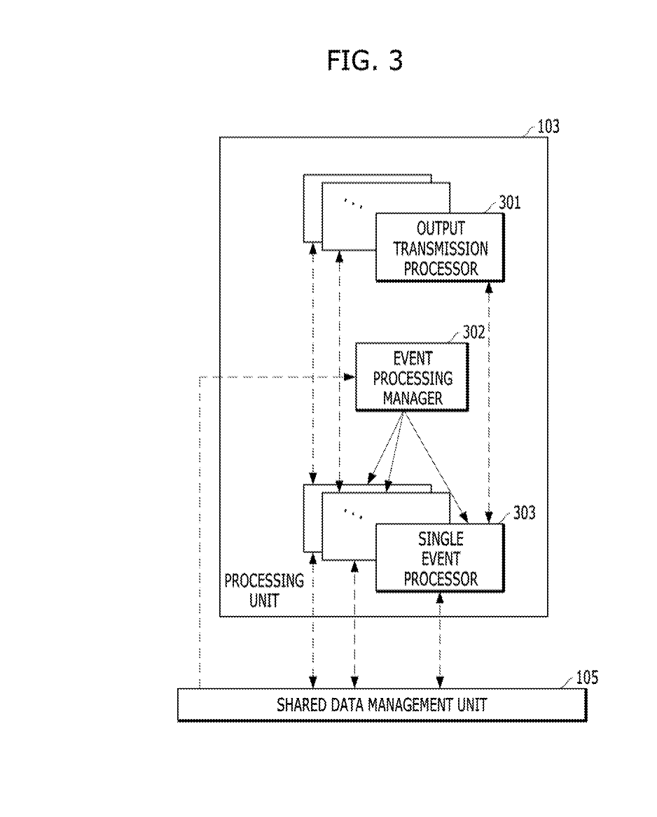

The processing unit 103 may analyze the CCTV images received as the shared data from the shared data management unit 105, based on the SVM learning algorithm and detect whether a disaster situation occurred. That is, the processing unit 103 may perform image processing, machine learning and image analysis using the CCTV images stored as the shared data in the shared data management unit 105, in order to detect whether a disaster situation occurred. For this operation, the processing unit 103 may determine the number of CCTV camera inputs, using the CCTV images stored as the shared data in the shared data management unit 105, and generate single event processor instances for processing events and output transmission processor instances for managing output data in FIG. 3.

Furthermore, the processing unit 103 may independently perform monitoring on CCTV images, such as fire, flood building abnormality, unattended guarding and distribution monitoring, according to a disaster detection mode preset by user input data. At this time, the disaster detection mode may be preset by the user input data and stored in an event processing manager 302, and used when each of the single event processors 303 determines whether a disaster situation occurred.

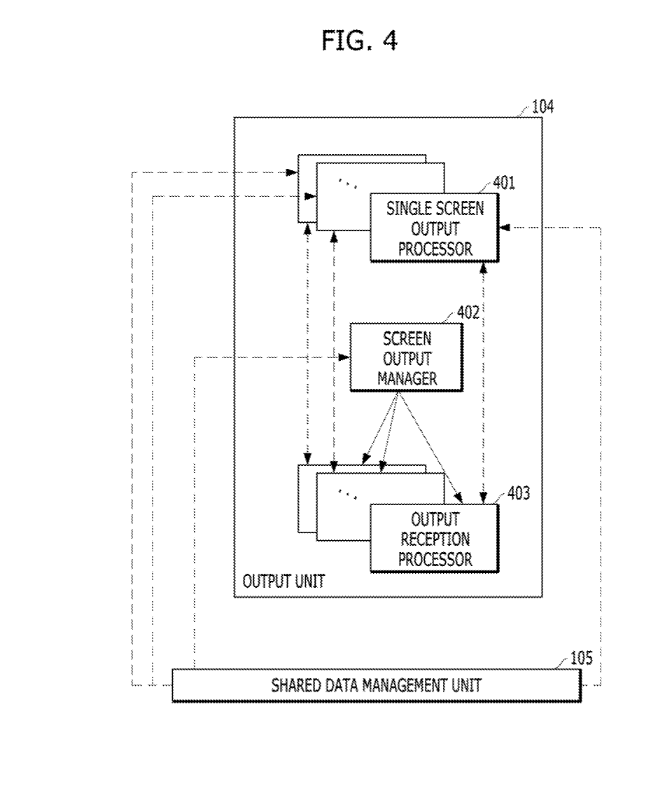

The output unit 104 may receive the information on disaster situation occurrence and output the received information on a screen, or receive CCTV images and output the received CCTV images on the screen. That is, the output unit 104 may receive the information on disaster situation occurrence, detected by the processing unit 103, and inform a user of the information. Furthermore, the output unit 104 may receive CCTV images as shared data in the shared data management unit 105, output the received CCTV images on the screen, and create a log file for the corresponding data, if necessary. For this operation, the output unit 104 may determine the number of CCTV camera inputs, using the CCTV images stored as the shared data in the shared data management unit 105, and generate single screen output processor instances and output reception processor instances of FIG. 4.

At this time, the CCTV images stored in the form of shared data may be outputted to preset positions of the screen by the single screen output processors 401 of FIG. 4, and the output reception processors 403 may receive, the information on disaster situation occurrence from the output transmission processors 301 of FIG. 3 and output an additional alarm (for example, sound) in addition to the screen output through the single screen output processors 401.

As described above, the input unit 102, the processing unit 103 and the output unit 104 of FIG. 1, which are included in the system for early detecting disasters based on an SVM may be independently operated for each function, and also independently perform their operations according to the CCTV images. Thus, the system can detect different disaster situations at the same time, according to the disaster detection mode preset by the user input data.

FIG. 2 is a detailed configuration diagram of the input unit 102 of FIG. 1.

As illustrated in FIG. 2, the input unit 102 may include one CCTV input manager 201 and a plurality of single CCTV input processors 202.

The CCTV input manager 201 may generate and manage single CCTV input processor instances each of which is capable of independently decoding a CCTV image and converting the decoded CCTV image into shared data, according to the number of CCTV camera inputs.

Each of the single CCTV input processors 202 may receive an encoded CCTV image from the CCTV camera 101 allocated thereto, decode the received image, convert the decoded image into shared data, and transmit the shared data to the shared data management unit 105.

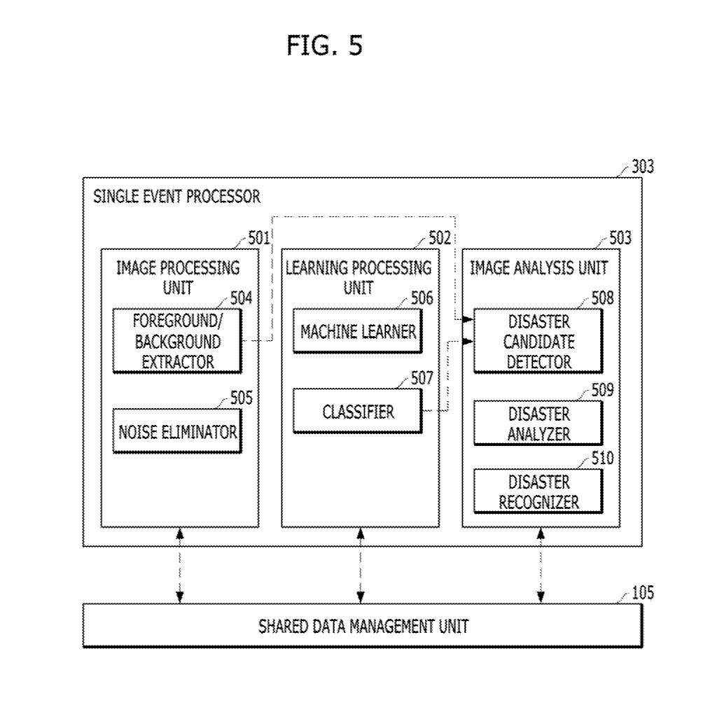

FIG. 3 is a detailed configuration diagram of the processing unit 103 of FIG. 1, and FIG. 5 is a detailed configuration diagram of a single event processor 303 of FIG. 3.

As illustrated in FIG. 3, the processing unit 103 may include a plurality of output transmission processors 301 one event processing manager 302 and a plurality of single event processors 303.

The event processing manager 302 may receive an event for a CCTV image input from the shared data management unit 105, and generate a single event processor instance. Then, the event processing manager 302 may receive a shared data change completion event, and connect the corresponding single event processor 303 to process the event. The shared data change completion event may indicate an event to notify that the shared data were changed.

The single event processors 303 may receive the shared data stored in the shared data management unit 105 and perform image processing, machine learning and image analysis to independently detect whether a disaster situation occurred. The single event processor 303 will be described later in detail with reference to FIG. 5.

The output transmission processors 301 may maintain one-to-one connection to the single event processors 303, and transmit the information on disaster situation occurrence, detected by the single event processor 303, to the output reception processors 403 of FIG. 4 through the shared data management unit 105.

As illustrated in FIG. 5, the single event processor 303 may be divided into three parts or an image processing unit 501, a learning processing unit 502 and an image analysis unit 503.

The image processing unit 501 may include a foreground/background extractor 504 and a noise eliminator 505. The image processing unit 501 may receive the shared data stored in the shared data management unit 105 and perform pre-processing on the received data.

At this time, the foreground/background extractor 504 may extract a foreground image and a background image from the CCTV image provided as the shared data, and set the extracted foreground image to a first candidate group of various disaster situations.

The noise eliminator 505 may eliminate noise which can be generated from the CCTV image, eliminate noise from the extracted foreground image or eliminate a part which cannot serve as a candidate group (for example, a candidate group with a narrow area from which additional characteristics cannot be extracted during the subsequent process), thereby reducing misdetection when an actual disaster situation is detected.

The learning processing unit 502 may include a machine learner 506 and a classifier 507, and perform an operation related to machine learning based on the SVM.

At this time, the machine learner 506 may generate a support vector to be used in the classifier 507 through pre-learning, before the classifier 507 starts detection. The machine learner 506 may collect CCTV images on a basis of predetermined time, in order to utilize the CCTV images as learning data for machine learning, and update the support vector through a background operation.

The classifier 507 may extract a second candidate group of various disaster situations, using the support vector generated by the machine learner 506.

The image analysis unit 503 may include a disaster candidate detector 508, a disaster analyzer 509 and a disaster recognizer 510. The image analysis unit 503 may receive the first and second candidate groups of various disaster situations, and detect a disaster situation.

The image analysis unit 503 may include a disaster candidate detector 508, a disaster analyzer 509 and a disaster recognizer 510. The image analysis unit 503 may receive the first and second candidate groups of various disaster situations, and detect a disaster situation.

When the potential candidate group is detected, the disaster candidate detector 508 may use different characteristics according to the disaster detection modes such as fire monitoring, flood monitoring, building exterior monitoring, unattended guarding and distribution monitoring. According to each of the disaster detection modes, a different potential candidate group may be detected.

For example, in the case of fire, the disaster candidate detector 508 may use color values in various color formats (for example, Gray, RGB, YCbCr and HSV) and a color mean and standard deviation which are created by the color values, in order to detect flame and smoke. In the case of flood the disaster candidate detector 508 may use template matching information for recognizing a flooding table. In the case of building exterior monitoring and distribution monitoring, the disaster candidate detector 508 may use a color information difference and label difference information based on the color information difference. In the case of unattended guarding, the disaster candidate detector 508 may use information on whether a foreground image has been extracted.

The disaster analyzer 509 may receive the potential candidate group detected by the disaster candidate detector 508, and determine a final candidate group by additionally using temporal and spatial elements. The temporal and spatial elements may include the duration of the potential candidate group and the area of the extracted candidate group in the CCTV image.

The disaster recognizer 510 may combine the final candidate group determined by the disaster analyzer 509 and external input information, and recognize the disaster situation. The external input information may include an area of interest which a user is intended to monitor and sensitivity which is the area ratio of the area of interest to the extracted candidate group. At this time the external input information such as the area of interest and the sensitivity may be set by the user through a user interface, and the set external input information may be stored in the event processing manager 302 and used by the single event processors 303.

As such, when the disaster recognizer 510 recognizes a disaster situation, each of the single event processors 303 may set the disaster situation to the output transmission processor 301 connected thereto, and transmit information to the output reception processor 403of the output unit 104, the information indicating that the situation received from the corresponding CCTV camera is a disaster situation.

FIG. 4 is a detailed configuration diagram of the output unit 104 of FIG. 1.

As illustrated in FIG. 4, the output unit 104 may include a plurality of single screen output processors 401, a screen output manager 402 and a plurality of output reception processors 403. The plurality of single screen output processors 401 may output CCTV images on the screen in one-to-one response to the CCTV images. The screen output manager 402 may generate and manage single screen output processor instances. The plurality of output reception processors 403 may receive information on a disaster situation.

The screen output manager 402 may receive an event for the number of CCTV camera inputs (that is the number of CCTV image inputs) from the shared data management unit 105, and generate the same number of single screen output processor instances as the number of CCTV camera inputs.

The screen output manager 402 may receive an event to output an analyzed CCTV image on the screen, and transmit the event to the corresponding single screen output processor 401 to output the CCTV image.

The single screen output processor 401 receiving the screen output event may output the decoded CCTV image to a position which is determined during initialization, such that the user can check the CCTV image through the screen with the naked eye.

The output reception processors 403 may correspond one-to-one to the output transmission processors 301 of the processing unit 103, and correspond one-to-one to the single screen output processors 401. At this time, when the output reception processor 403 receives a disaster situation from the output transmission processor 301, the output reception processor 403 may transmit an event to the single screen output processor 401 to inform the user of the disaster situation. Furthermore, the output reception processor 403 may inform the user of the disaster situation using another device, in addition to the screen output.

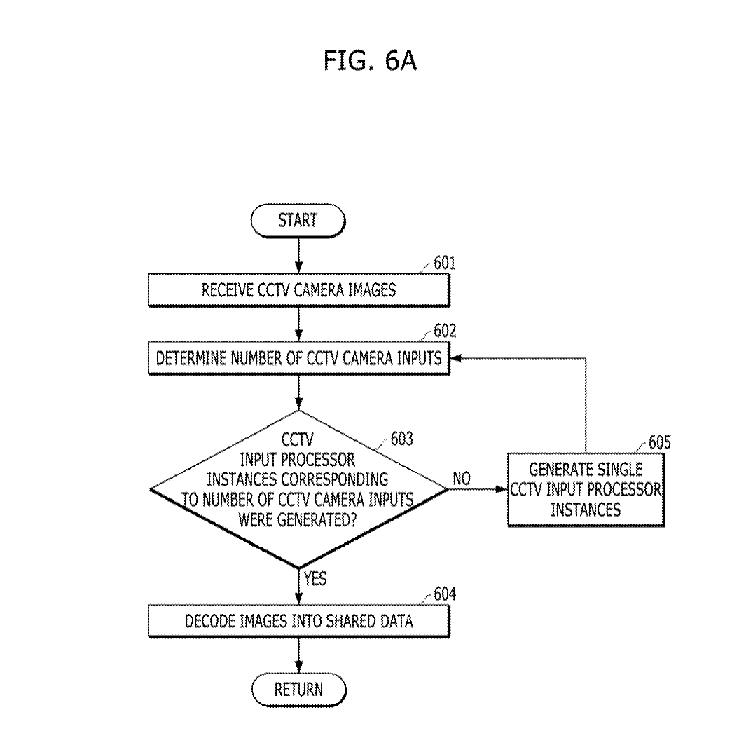

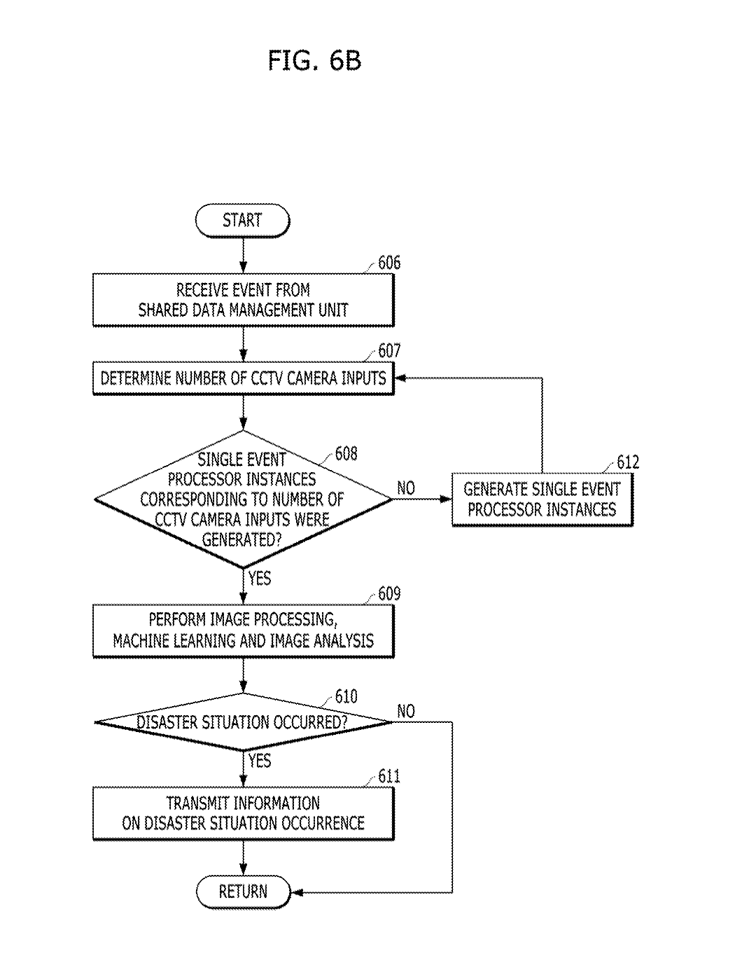

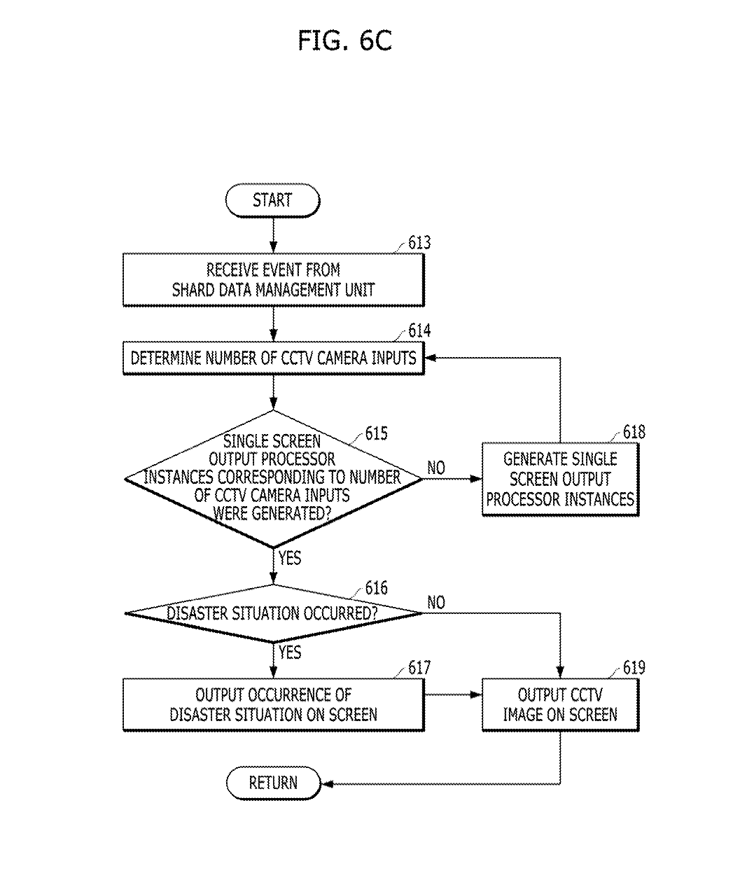

FIGS. 6A to 6C are flowcharts illustrating a method for early detecting disasters based on an SVM in accordance with an embodiment of the present invention. The method may include receiving encoded images from a plurality of CCTV cameras existing in a local or remote area through the input unit 102; decoding the received encoded images and converting the decoded images into shared data; analyzing the CCTV images provided as the shared data based on the SVM learning algorithm and determining whether a disaster situation occurred; and outputting the determination result and the CCTV images such that a user can check whether the disaster situation occurred.

Referring to FIG. 6A, the operation flow of the input unit 102 will be described as follows.

First, the CCTV input manager 201 of the input unit 102 may receive encoded CCTV images from the plurality of CCTV cameras 101 at step 601.

The CCTV input manager 201 of the input unit 102 may determine the number of CCTV camera inputs (that is, the number of CCTV image inputs), using the CCTV images inputted from the plurality of CCTV cameras 101, at step 602.

The CCTV input manager 201 of the input unit 102 may check whether single CCTV input processor Instances corresponding to the number of CCTV camera inputs were generated, at step 603. When the single CCTV input processor instances corresponding to the number of CCTV camera inputs were not generated, the CCTV input manager 201 may generate the single CCTV input processor instances at step 605, and proceed to step 602.

When it is checked at step 603 that the single CCTV input processor instances corresponding to the number of CCTV camera inputs were generated, the single CCTV input processors 202 may decode the encoded CCTV images, convert the decoded CCTV images into shared data, and transmit the shared data to the shared data management unit 105, at step 604.

Referring to FIG. 6B, the operation flow of the processing unit 103 will be described as follows.

First, the event processing manager 302 of the processing unit 103 may receive an event of CCTV image inputs from the shared data management unit 105 at step 606 and check the number of CCTV camera inputs at step 607.

The event processing manager 302 of the processing unit 103 may check whether single event processor instances corresponding to the number of CCTV camera inputs were generated, at step 608. When the single event processor instances corresponding to the number of CCTV camera inputs were not generated, the single event processing manager 302 may generate the single event processor instances at step 612, and proceed to step 607.

When it is checked at step 608 that the single event processor instances were generated, the single event processors 303 may receive the shared data according to a shared data change completion event, and perform image processing, machine learning and image analysis, at step 609. Then, the single event processors 303 may determine whether a disaster situation occurred, at step 610.

When it is determined at step 610 that a disaster situation occurred, the output transmission processor 301 may transmit the information on disaster situation occurrence to the output reception processor 403 at step 611.

The output transmission processor 301 may transmit the information on disaster situation occurrence to the output reception processor 403 through the shared data management unit 105. The shared data management unit 105 may store and manage the information on disaster situation occurrence.

Referring to FIG. 6C, the operation flow of the output unit 164 will be described as follows.

First, the screen output manager 402 of the output unit 104 may receive an event of CCTV image inputs from the shared data management unit 105 at step 613, and determine the number of CCTV camera inputs at step 614.

The screen output manager 402 of the output unit 104 may check whether single screen output processor instances corresponding to the number of CCTV camera inputs were generated, at step 615. When the single screen output processor instances corresponding to the number of CCTV camera inputs were not generated, the screen output manager 402 may generate the single screen output processor instances at step 618, and then proceed to step 614. On the other hand, when the single screen output processor instances corresponding to the number of CCTV camera inputs were generated, the screen output manager 402 may check whether a disaster situation occurred, at step 616.

When it is checked at step 616 that no disaster situation occurred, the single screen output processors 401 may output the decoded CCTV images to positions determined during initialization, such that a user can check the CCTV images through the screen with the naked eye, at step 619. On the other hand, when it is checked at step 616 that a disaster situation occurred, the single screen output processors 401 may output the occurrence of the disaster situation on the screen at step 617, and output the CCTV images on the screen at step 619.

The method for early detecting disasters based on an SVM in accordance with the embodiment of the present invention may be embodied in the form of a program command which can be executed through various computing units, and written to a computer readable recording medium. The computer readable recording medium may include a program command, a data file, a data structure or combinations thereof. The program command written to the medium may include program commands which are specifically designed for the present invention or publicly known to those skilled in the computer software industry. Examples of the computer readable recording medium may include magnetic media such as hard disk, floppy disk and magnetic tape, optical media such as CD-ROM and DVD, magneto-optical media such as floptical disk, and hardware devices such as ROM RAM and flash memory, which are configured to store and execute a program command. The media may include transmission media, such as optical or metal line and waveguide, which include a carrier wave to designate a program command and a data structure. Examples of the program command may include not only machine codes created by a compiler, but also high-level language codes which can be executed in a computer by an interpreter or the like. The hardware device may be configured to operate as one or more software modules for performing the operation of the present invention, and vice versa.

In accordance with the embodiments of the present invention, the system and method for early detecting disasters based on the SVM can analyze images received from the plurality of CCTV cameras using the SVM learning algorithm, early detect a disaster situation such as fire, flood, building abnormality, distribution monitoring or unattended guarding, and inform a user of the disaster situation. Thus, the system and method can minimize personnel and material loss, and efficiently use resources required for system operation, thereby providing many advantages in terms of maintenance.

Furthermore, the input unit, the processing unit and the output unit may be independently configured, and common data may be processed separately from the independent units. Thus, the system and method may have a low-level computational complexity.

Furthermore, the system and method can process a plurality of high-resolution images at the same time, and independently perform image processing and analysis on the respective images.

Furthermore the system and method may analyze a disaster situation using the SVM learning algorithm thereby improving the reliability,

While the present invention has been described with respect to the specific embodiments, it will be apparent to those skilled in the art that various changes and modifications may be made without departing from the spirit and scope of the invention as defined in the following claims.

What is claimed is:

1. A system for early detecting disasters based on an SVM (Support Vector Machine) comprising:
an input unit configured to decode a plurality of input images and convert the decoded images into shared data;
a shared data management unit configured to manage the shared data provided from the input unit;
a processing unit configured to analyze the shared data provided from the shared data management unit based on an SVM learning algorithm, and detect whether a disaster situation occurred; and
an output unit configured to output the detection result of the processing unit.

2. The system of claim 1, wherein the input unit receives encoded CCTV images from a plurality of CCTV cameras, decodes the received CCTV images, converts the decoded CCTV images into shared data, and transmits the shared data to the shared data management unit.

3. The system of claim 1, wherein the input unit comprises:
a CCTV input manager configured to generate single CCTV input processor instances; and
a plurality of single CCTV input processors configured to independently decode CCTV images according to the number of CCTV image inputs, and convert the decoded CCTV images into shared data.

4. The system of claim 1, wherein the processing unit receives the CCTV images stored as the shared data in the shared data management unit, analyzes the received CCTV images based on the SVM learning algorithm, and detects whether a disaster situation occurred.

5. The system of claim wherein the processing unit independently performs monitoring on each of the CCTV images according to a preset disaster detection mode.

6. The system of claim 1, wherein the processing unit comprises:
an event processing manager configured to receive an event of CCTV image inputs from the shared data management unit, generate single event processor instances, receive a shared data change completion event, and connect corresponding single event processors to process the event;
a plurality of single event processors configured to receive the shared data from the shared data management unit according to the shared data change completion event, perform image processing, machine learning and image analysis, and independently detect whether a disaster situation occurred; and
a plurality of output transmission processors configured to transmit the detection results of the single event processors.

7. The system of claim 6, wherein the single event processor comprises:
an image processing unit configured to receive the shared data stored in the shared data management unit, extract foreground and background images, and eliminate noise;
a learning processing unit configured to perform machine learning based on the SVM; and
an image analysis unit configured to receive candidate groups of various disaster situations from the image processing unit and the learning processing unit, and detect a disaster situation.

8. The system of claim 7, wherein the image processing unit comprises:
a foreground/background extractor configured to extract foreground and background images from a CCTV image provided in the form of shared data, and set the extracted foreground image to a first candidate group of various disaster situations; and
a noise eliminator configured to eliminate noise generated in the CCTV image, noise generated in the extracted foreground image or an unimportant part which does not serve as a candidate group.

9. The system of claim 8, wherein the learning processing unit comprises:
a machine learner configured to generate a support vector to be used by a classifier though pre-learning before the classifier starts extraction; and
the classifier configured to extract a second candidate group of various disaster situations using the support vector generated by the machine learner.

10. The system of claim 9, wherein the image analysis unit comprises:
a disaster candidate detector configured to detect a potential candidate group using the first candidate group extracted by the foreground/background extractor, the second candidate group extracted by the classifier, characteristics, based on the disaster detection mode;
a disaster analyzer configured to receive the potential candidate group detected by the disaster candidate detector, and determine a final candidate group using temporal and spatial elements; and
a disaster recognizer configured to combine external input information and the final candidate group determined by the disaster analyzer and recognize a disaster situation.

11. The system of claim 1, wherein the output unit outputs the disaster situation detected by the processing unit and the CCTV images provided from the shared data management unit.

12. The system of claim 1, wherein the output unit comprises:
a plurality of output reception processors configured to receive information on the disaster situation detected by the processing unit;
a screen output manager configured to generate single screen output processor instances; and
a plurality of single screen output processors configured to output the disaster situation received through the plurality of output reception processors and the CCTV images provided from the shared data management unit.

13. A method for early detecting disasters based on an SVM, comprising:
receiving encoded images from a plurality of cameras;
decoding the received encoded images, and converting the decoded images into shared data;
analyzing the images provided as the shared data based on an SVM learning algorithm, and determining whether a disaster situation occurred; and
outputting the detection result.

14. The method of claim 13, wherein the analyzing of the images provided as the shared data comprises independently performing monitoring on each of the images according to a preset disaster detection mode.

15. A computer readable recording medium which stores a program for embodying:
receiving encoded images from a plurality of cameras;
decoding the received encoded images, and converting the decoded images into shared data;
analyzing the images provided as the shared data based on an SVM learning algorithm, and determining whether a disaster situation occurred; and
outputting the detection result.
